(19) United States
(12) Patent Application Publication
(10) Pub. No.: US 2024/0241148 A1
(43) Pub. Date: Jul. 18, 2024

(54) Sensor Module

(71) Applicant: SEIKO EPSON CORPORATION, Tokyo (JP)

(72) Inventor: Yasushi NAKAOKA, Shiojiri (JP)

(21) Appl. No.: 18/413,117

(22) Filed: Jan. 16, 2024

(30) Foreign Application Priority Data
Jan. 17, 2023 (JP) 2023-004934

(51) Int. Cl. G01P 1/02; G01P 3/00; G01P 15/08; G01P 15/18

(52) U.S. Cl. CPC G01P 1/02; G01P 3/00; G01P 15/08; G01P 15/18

(57) ABSTRACT

A sensor module includes: a housing; first to n-th sensor devices accommodated in the housing and configured to detect first to n-th accelerations respectively applied to first to n-th positions of the housing, n being an integer of 2 or more; and a processing circuit configured to convert, based on an angular velocity applied to the housing, the first to n-th accelerations into first to n-th reference position accelerations, respectively, the reference position accelerations being accelerations applied to a predetermined reference position of the housing.

The present application is based on, and claims priority from JP Application Serial Number 2023-004934, filed Jan. 17, 2023, the disclosure of which is hereby incorporated by reference herein in its entirety.

### BACKGROUND

### 1. Technical Field

The present disclosure relates to a sensor module.

### 2. Related Art

JP-A-2021-196191 discloses an inertia sensor apparatus including: a plurality of sensor modules each including an inertia sensor and a correction circuit that generates a corrected signal by performing misalignment correction in which a correction coefficient is applied to a signal output from the inertia sensor such that a plurality of detection axes of the inertia sensor are orthogonal to one another; a matching processor that generates a plurality of matched signals by applying a correction coefficient for causing the plurality of detection axes of each of the plurality of sensor modules to match with a plurality of detection axes of any one of the plurality of sensor modules to each corrected signal; and a combining processor that combines the plurality of matched signals with the plurality of corrected signals and outputs the combined signal. According to the inertia sensor apparatus disclosed in JP-A-2021-196191, since a deviation of the detection axes between the plurality of sensor modules is eliminated, deterioration of detection accuracy of inertia data can be prevented. In addition, in the inertia sensor apparatus disclosed in JP-A-2021-196191, acceleration sensors included in the inertia sensors included in each sensor module are close to each other, and a difference in acceleration received by each of the plurality of acceleration sensors can be limited small.

### PATENT LITERATURE

JP-A-2021-196191 is an example of the related art.

However, since the plurality of acceleration sensors cannot be disposed at exactly the same position, outputs of the plurality of acceleration sensors may be different when a rotational motion is applied to the plurality of acceleration sensors.

### SUMMARY

An aspect of a sensor module according to the present disclosure includes:
a housing;
first to n-th sensor devices accommodated in the housing and configured to detect first to n-th accelerations respectively applied to first to n-th positions of the housing, n being an integer of 2 or more; and
a processing circuit configured to convert, based on an angular velocity applied to the housing, the first to n-th accelerations into first to n-th reference position accelerations, respectively, the reference position accelerations being accelerations applied to a predetermined reference position of the housing.

Another aspect of a sensor module according to the present disclosure includes:
a housing;
first to n-th sensor devices accommodated in the housing and configured to detect first to n-th accelerations respectively applied to first to n-th positions of the housing, n being an integer of 2 or more; and
a processing circuit configured to set the first position as a predetermined reference position of the housing to set the first acceleration as a first reference position acceleration that is an acceleration applied to the reference position, and convert, based on an angular velocity applied to the housing, the second to n-th accelerations into second to n-th reference position accelerations, respectively, the reference position accelerations being accelerations applied to the reference position.

### BRIEF DESCRIPTION OF THE DRAWINGS

FIG. 1 is a diagram illustrating a configuration of a sensor module according to a first embodiment.

FIG. 2 is an exploded perspective view of a sensor device.

FIG. 3 is a top view illustrating a circuit substrate included in the sensor device.

FIG. 4 is a bottom view of the circuit substrate illustrated in FIG. 3.

FIG. 5 is a diagram illustrating an example of a functional configuration of the sensor device.

FIG. 6 is a perspective view of the sensor module.

FIG. 7 is a plan view of an inside of the sensor module.

FIG. 8 is an exploded perspective view of a substrate and the sensor module.

FIG. 9 is a diagram illustrating another example of the functional configuration of the sensor device.

FIG. 10 is a diagram illustrating another configuration of the sensor module according to the first embodiment.

FIG. 11 is a diagram illustrating a configuration of a sensor module according to a second embodiment.

FIG. 12 is a diagram illustrating a configuration of a sensor module according to a third embodiment.

FIG. 13 is a diagram illustrating a configuration of a sensor module according to a fourth embodiment.

### DESCRIPTION OF EMBODIMENTS

Hereinafter, preferred embodiments of the present disclosure will be described in detail with reference to the drawings. The embodiments to be described below do not unduly limit contents of the present disclosure described in the claims. In addition, not all configurations to be described below are necessarily essential components of the present disclosure.

### 1. First Embodiment

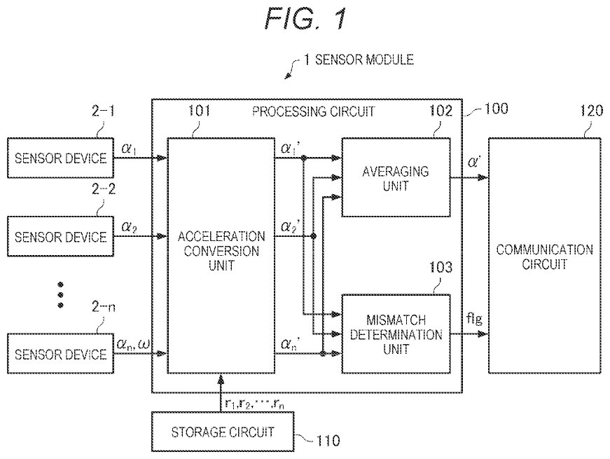

FIG. 1 is a diagram illustrating a configuration of a sensor module according to a first embodiment. As illustrated in FIG. 1, a sensor module 1 according to the first embodiment includes sensor devices 2-1 to 2-n, a processing circuit 100, a storage circuit 110, and a communication circuit 120. n is an integer of 2 or more.

The sensor devices 2-1 to 2-n are accommodated in a housing (not illustrated) of the sensor module 1, and detect accelerations α₁ to αₙ applied to first to n-th positions of the housing, respectively. That is, for each integer j of 1 or more and n or less, the sensor device 2-j includes at least an acceleration sensor provided at the j-th position, and the acceleration sensor detects the acceleration αⱼ. The sensor device 2-n further detects an angular velocity ω applied to the housing of the sensor module 1. That is, the sensor device 2-n includes an angular velocity sensor together with an acceleration sensor, and the angular velocity sensor detects the angular velocity ω applied to the housing.

For example, the sensor devices 2-1 to 2-(n−1) may be three-axis acceleration sensor devices, and the sensor device 2-n may be an inertia measurement unit including a three-axis acceleration sensor and a three-axis angular velocity sensor. Further, each of the first to n-th sensor devices 2-1 to 2-n may be an inertia measurement unit.

Hereinafter, a case where the sensor devices 2-1 to 2-n are inertia measurement units having the same structure will be described as an example, and a structure and a function thereof will be described. Hereinafter, any one of the sensor devices 2-1 to 2-n may be referred to as a sensor device 2.

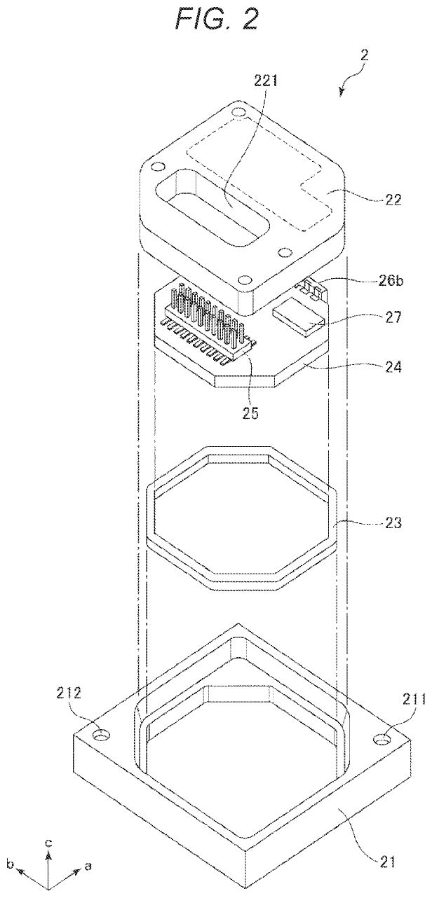

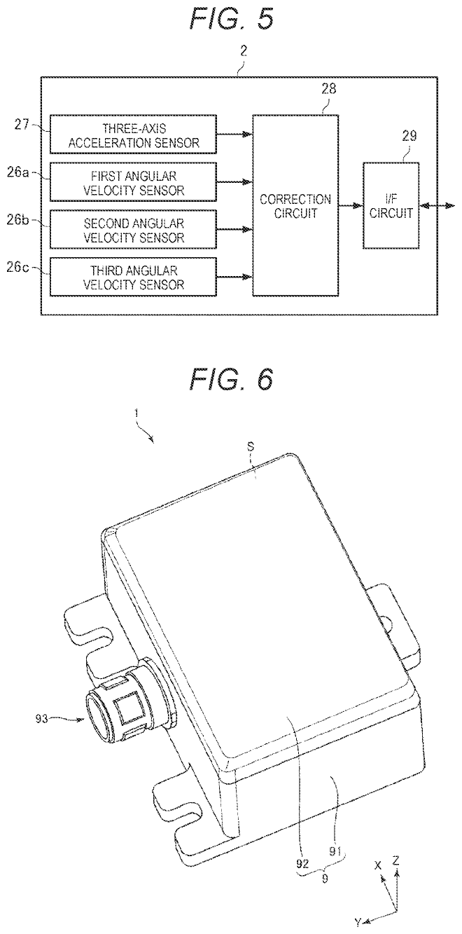

FIGS. 2 to 4 are diagrams illustrating examples of a structure of the sensor device 2. FIG. 5 is a diagram illustrating an example of a functional configuration of the sensor device 2.

As illustrated in FIG. 2, the sensor device 2 includes an outer case 21, an inner case 22, a joining member 23, and a circuit substrate 24. The outer case 21 includes a recess into which the inner case 22 is inserted. The outer case 21 and the inner case 22 are joined to each other by the joining member 23 in a state of accommodating and holding the circuit substrate 24. The sensor device 2 has a square shape when viewed from above, that is, from a direction along a c-axis illustrated in FIG. 2. The outer case 21 has, for example, screw holes 211 and 212 respectively provided in a pair of corner portions located at diagonally opposite corners of the upper surface thereof. The sensor device 2 can be fixed to a substrate 10 by being screwed by using the screw holes 211 and 212.

As illustrated in FIG. 5, the sensor device 2 includes a three-axis acceleration sensor 27, a first angular velocity sensor 26a, a second angular velocity sensor 26b, a third angular velocity sensor 26c, a correction circuit 28, and an interface circuit 29.

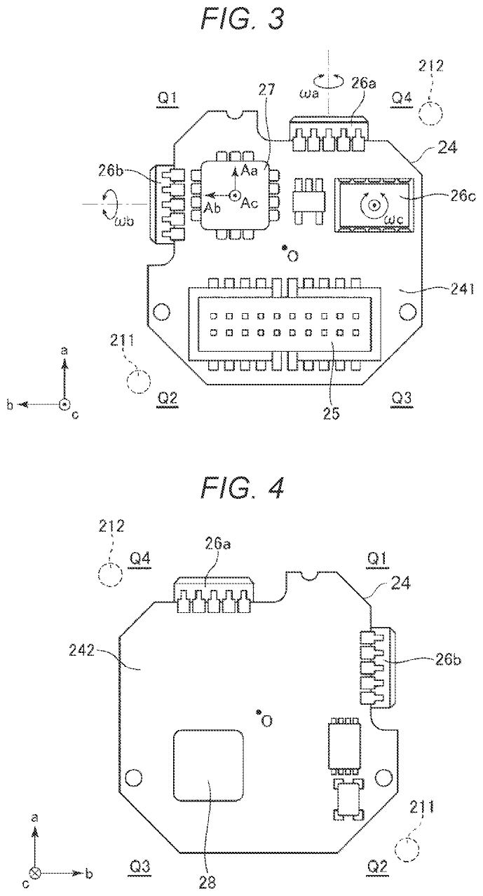

As illustrated in FIGS. 3 and 4, a module connector 25, the first angular velocity sensor 26a, the second angular velocity sensor 26b, the third angular velocity sensor 26c, the three-axis acceleration sensor 27, the correction circuit 28, and the like are mounted at the circuit substrate 24. The module connector 25 couples the sensor device 2 and the substrate 10. For example, the module connector 25 is exposed to the substrate 10 through an opening 221 provided in the inner case 22. The first angular velocity sensor 26a detects an angular velocity ωₐ about an a-axis. The second angular velocity sensor 26b detects an angular velocity ω_{b} about a b-axis. The third angular velocity sensor 26c detects an angular velocity ω_{c} about a c-axis. The three-axis acceleration sensor 27 detects an acceleration Aₐ in a direction along the a-axis, an acceleration A_{b} in a direction along the b-axis, and an acceleration A_{c} in a direction along the c-axis. The three detection axes including the a-axis, the b-axis, and the c-axis are defined for each sensor device 2.

The correction circuit 28 is implemented with, for example, an integrated circuit. The correction circuit 28 is coupled to the three-axis acceleration sensor 27, the first angular velocity sensor 26a, the second angular velocity sensor 26b, and the third angular velocity sensor 26c via the circuit substrate 24. In general, signals output from the three-axis acceleration sensor 27, the first angular velocity sensor 26a, the second angular velocity sensor 26b, and the third angular velocity sensor 26c have misalignment, which is an angular error with respect to the three detection axes caused by, for example, a deviation during assembly of the sensor device 2. Therefore, the correction circuit 28 generates corrected signals by correcting the signals output from the three-axis acceleration sensor 27, the first angular velocity sensor 26a, the second angular velocity sensor 26b, and the third angular velocity sensor 26c such that the three detection axes of the sensor device 2 are orthogonal to one another. Specifically, the correction circuit 28 generates the corrected signals by executing misalignment correction in which a predetermined correction coefficient such as a rotation matrix is applied to the signals output from the three-axis acceleration sensor 27, the first angular velocity sensor 26a, the second angular velocity sensor 26b, and the third angular velocity sensor 26c. The three detection axes forming a three-dimensional orthogonal coordinate system are set for each sensor device 2.

In addition, the correction circuit 28 corrects offset errors and scale factor errors included in the signals output from the three-axis acceleration sensor 27, the first angular velocity sensor 26a, the second angular velocity sensor 26b, and the third angular velocity sensor 26c. The correction circuit 28 outputs the corrected signals to the processing circuit 100 via the interface circuit 29.

The circuit substrate 24 has, for example, a square shape when viewed from the direction along the c-axis. Defining four quadrants defined around a center O of the circuit substrate 24 as a first quadrant Q1, a second quadrant Q2, a third quadrant Q3, and a fourth quadrant Q4, the three-axis acceleration sensor 27 is disposed in the first quadrant Q1.

The module connector 25 is disposed at an upper surface 241 of the circuit substrate 24 in the second quadrant Q2 and the third quadrant Q3. The first angular velocity sensor 26a is disposed at a side surface of the circuit substrate 24 in the fourth quadrant Q4. The second angular velocity sensor 26b is disposed at the side surface of the circuit substrate 24 in the first quadrant Q1. The third angular velocity sensor 26c is disposed at the upper surface 241 of the circuit substrate 24 in the fourth quadrant Q4. The three-axis acceleration sensor 27 is disposed at the upper surface 241 of the circuit substrate 24 in the first quadrant Q1. The correction circuit 28 is disposed at a lower surface 242 of the circuit substrate 24 in the third quadrant Q3. The screw hole 211 is disposed in the second quadrant Q2, and the screw hole 212 is disposed in the fourth quadrant Q4.

FIGS. 6 to 8 are diagrams illustrating an example of a structure of the sensor module 1 including three sensor devices 2A, 2B, and 2C having the structure of FIGS. 2 to 4. The sensor devices 2A, 2B, and 2C correspond to the sensor devices 2-1, 2-2, and 2-3 of FIG. 1, respectively.

As illustrated in FIGS. 6 to 8, the sensor module 1 includes, for example, the substrate 10, the sensor devices 2A, 2B, and 2C mounted at the substrate 10, the processing circuit 100, and a container 9 as a housing accommodating the substrate 10, the sensor devices 2A, 2B, and 2C, and the processing circuit 100 therein. The sensor module 1 is an inertia measurement unit that detects accelerations in directions of three axes and an angular velocity around the three axes. The sensor module 1 detects, for example, a motion state of a moving body, such as a vehicle, a robot, and a drone, an electronic instrument, such as a smartphone and a tablet terminal, and a variety of other targets. The motion state includes, for example, a position, a posture, a velocity, an acceleration, and an angular velocity.

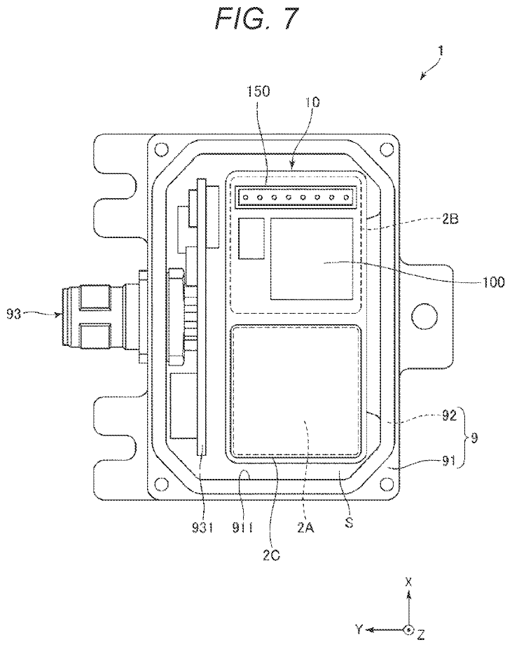

As illustrated in FIGS. 6 and 7, the container 9 includes a base 91 having a recess 911 opening upward, and a lid 92 fixed to the base 91 to close an opening of the recess 911. The container 9 schematically has a rectangular flat plate shape. The base 91 and the lid 92 define an accommodation space S inside the recess 911 sealed by the lid 92. The accommodation space S is a space for accommodating components such as the substrate 10, the sensor devices 2A, 2B, and 2C, and the processing circuit 100. The container 9 protects the components accommodated in the accommodation space S from dust, moisture, ultraviolet rays, impact, and the like.

The base 91 and lid 92 may be made of aluminum (Al). In addition, examples of materials of the base 91 and the lid 92 include metal materials such as Al alloy, zinc (Zn), and stainless steel, a variety of ceramics, a variety of resin materials, and composite materials thereof.

The sensor module 1 includes a connector 93 attached to a side wall of the base 91 and a communication substrate 931 disposed in the accommodation space S. The connector 93 is a receptacle that electrically couples an interior and an exterior of the container 9. The communication substrate 931 includes a circuit that processes communication between the sensor module 1 and another apparatus.

The substrate 10 is a circuit substrate including a variety of elements and wirings. The sensor devices 2A, 2B, and 2C, the processing circuit 100, an internal connector 150, and the like are mounted at the substrate 10. The substrate 10 is relatively fixed, for example, to the base 91.

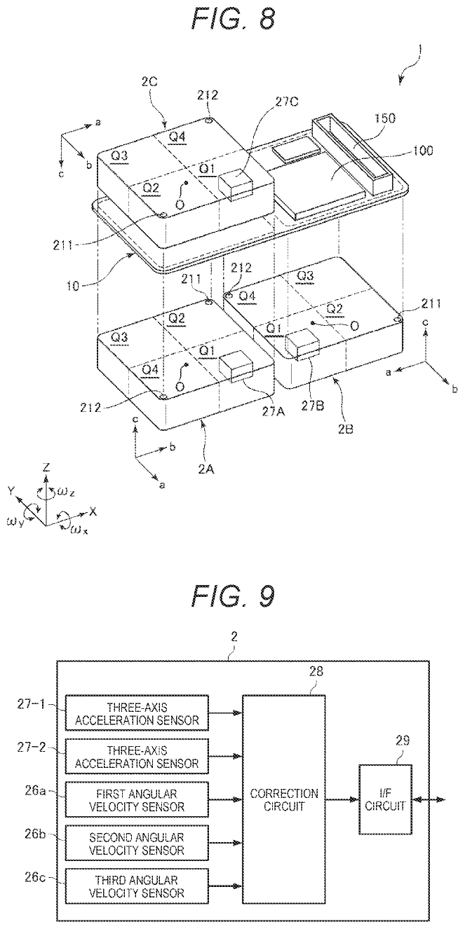

As illustrated in FIGS. 7 and 8, the sensor devices 2A and 2B are arranged along an X-axis at a lower surface of the substrate 10. The sensor device 2C is disposed at the upper surface of the substrate 10 to overlap with the sensor device 2A when viewed from the direction along a Z-axis. The processing circuit 100 and the internal connector 150 are disposed at the upper surface of the substrate 10 to overlap with the sensor device 2B when viewed from the direction along the Z-axis. In this way, efficient disposition of the variety of components that are disposed in an area of the substrate 10 and the accommodation space S allows reduction in size of the sensor module 1.

The sensor devices 2A, 2B, and 2C are coupled to the processing circuit 100 via the substrate 10. The processing circuit 100 controls driving of the sensor devices 2A, 2B, and 2C. The processing circuit 100 is coupled to the communication substrate 931 via the internal connector 150 and a wiring (not illustrated) coupled to the internal connector 150.

As illustrated in FIG. 8, the sensor devices 2A, 2B, and 2C are disposed such that the first quadrants Q1 thereof are close to one another. That is, in the example illustrated in FIG. 8, a three-axis acceleration sensor 27A of the sensor device 2A and a three-axis acceleration sensor 27C of the sensor device 2C are disposed to overlap with each other when viewed from the direction along the Z-axis. The three-axis acceleration sensor 27A of the sensor device 2A and a three-axis acceleration sensor 27B of the sensor device 2B are disposed to overlap with each other when viewed from the direction along the X-axis. Accordingly, a difference in acceleration received by the three-axis acceleration sensors 27A, 27B, and 27C can be reduced to a small value.

Assuming that a reference position of the housing of the sensor module 1 is located at a position pₒ of a spatial coordinate system and the sensor device 2-j is mounted at a position rⱼ of a housing coordinate system, a position pⱼ of the spatial coordinate system is represented by Equation (1). For example, the position rⱼ is an acceleration sensitivity point position of the sensor device 2-j.

$${p}_{j} = {p}_{o} + {Cr}_{j} \qquad ( 1 )$$

In Equation (1), C is a coordinate transformation matrix representing a posture of housing coordinates with respect to spatial coordinates. By time-differentiating Equation (1), a velocity v of the sensor device 2-j in the spatial coordinate system is obtained as in Equation (2). Further, by time-differentiating Equation (2), the acceleration aⱼ of the sensor device 2-j in the spatial coordinate system is obtained as in Equation (3).

$${v}_{j} = {\dot{p}}_{j} = {v}_{o} + C ω \times {r}_{j} , {v}_{o} = {\dot{p}}_{o} \qquad ( 2 )$$

$${a}_{j} = {\dot{v}}_{j} = {a}_{o} + C ω \times ( ω \times {r}_{j} ) + C \dot{ω} \times {r}_{j} , {a}_{o} = {\dot{v}}_{o} \qquad ( 3 )$$

In Equations (2) and (3), vₒ is a spatial translation velocity of the reference position of the housing in the spatial coordinate system, α₀ is the acceleration of the reference position of the housing in the spatial coordinate system, and ω is a rotational angular velocity in the housing coordinate system. The angular velocity ω is the same value in the housing regardless of a mounting position of the sensor device 2-j.

The acceleration αⱼ detected by the sensor device 2-j is obtained by converting the acceleration αⱼ obtained by Equation (3) into the housing coordinate system as in Equation (4).

$${α}_{j} = {C}^{T} {a}_{j} = {α}_{o} + ω \times ( ω \times {r}_{j} ) + \dot{ω} \times {r}_{j} , {α}_{o} = {C}^{T} {a}_{o} \qquad ( 4 )$$

In Equation (4), αₒ is the acceleration of the reference position in the housing coordinate system. In Equation (4), Equation (5) is obtained by expressing a cross product in a matrix form.

$$\begin{matrix}{α}_{j} = {α}_{o} + [ \begin{matrix}0 & - {ω}_{z} & {ω}_{y} \\ {ω}_{z} & 0 & - {ω}_{x} \\ - {ω}_{y} & {ω}_{x} & 0\end{matrix} ] [ \begin{matrix}0 & - {ω}_{z} & {ω}_{y} \\ {ω}_{z} & 0 & - {ω}_{x} \\ - {ω}_{y} & {ω}_{x} & 0\end{matrix} ] {r}_{j} + [ \begin{matrix}0 & - {\dot{ω}}_{z} & {\dot{ω}}_{y} \\ {\dot{ω}}_{z} & 0 & - {\dot{ω}}_{x} \\ - {\dot{ω}}_{y} & {\dot{ω}}_{x} & 0\end{matrix} ] {r}_{j} = \\ {α}_{o} + [ \begin{matrix}- {ω}_{y}^{2} - {ω}_{z}^{2} & {ω}_{x} {ω}_{y} - {\dot{ω}}_{z} & {ω}_{x} {ω}_{z} + {\dot{ω}}_{y} \\ {ω}_{x} {ω}_{y} + {\dot{ω}}_{z} & - {ω}_{x}^{2} - {ω}_{z}^{2} & {ω}_{y} {ω}_{z} - {\dot{ω}}_{x} \\ {ω}_{x} {ω}_{z} - {\dot{ω}}_{y} & {ω}_{y} {ω}_{z} + {\dot{ω}}_{x} & - {ω}_{x}^{2} - {ω}_{y}^{2}\end{matrix} ] {r}_{j}\end{matrix} \qquad ( 5 )$$

From Equation (5), it can be understood that the acceleration applied to the sensor devices 2-1 to 2-n is different due to a difference in mounting position, and in particular, the difference in acceleration increases as the angular velocity ω increases. In the embodiment, the processing circuit 100 converts the accelerations α₁ to an detected by the sensor devices 2-1 to 2-n into accelerations α₁′ to αₙ′ applied to the reference position of the housing.

Referring back to FIG. 1, the processing circuit 100 includes an acceleration conversion unit 101, an averaging unit 102, and a mismatch determination unit 103.

The acceleration conversion unit 101 converts, based on the angular velocity ω applied to the housing of the sensor module 1 and detected by the sensor device 2-n, the accelerations α₁ to αₙ respectively applied to the first to n-th positions detected by the sensor devices 2-1 to 2-n into the reference position accelerations α₁′ to αₙ′, respectively, the reference position accelerations being accelerations applied to the predetermined reference position of the housing. The accelerations α₁ to αₙ and the reference position accelerations α₁′ to αₙ′ are accelerations of the sensor module 1 in the housing coordinate system, and the angular velocity ω is an angular velocity of the sensor module 1 in the housing coordinate system. The sensor devices 2-1 to 2-n may output the accelerations α₁ to αₙ in the housing coordinate system, or the sensor devices 2-1 to 2-n may output the accelerations in a sensor coordinate system and the acceleration conversion unit 101 may convert the accelerations into the accelerations α₁ to αₙ in the housing coordinate system. Further, the sensor device 2-n may output the angular velocity ω in the housing coordinate system, or the sensor device 2-n may output an angular velocity in the sensor coordinate system and the acceleration conversion unit 101 may convert the angular velocity into the angular velocity ω in the housing coordinate system. In the example of FIG. 8 described above, an abc coordinate system defined by the a-axis, the b-axis, and the c-axis of each sensor device 2 is the sensor coordinate system, and an XYZ coordinate system defined by the X-axis, a Y-axis, and the Z-axis of the sensor module 1 is the housing coordinate system.

Here, assume that a k-th angular velocity detected by the sensor device 2-n every sampling interval Δt is an angular velocity ωₖ=[ω_{x,k} ω_{y,k} ω_{z,k}]^{T}, and the k-th acceleration detected by the sensor device 2-j for each integer j of 1 or more and n or less is α_{j,K}=[α_{jx,k} α_{jy,k} α_{jz,k}]^{T}. From Equation (5) described above, Equation (6) for converting the k-th acceleration α_{j,k} into a reference position acceleration α_{j,k}′ is derived.

$$\begin{matrix}{α}_{j , k}^{′} = {α}_{j , k} - [ \begin{matrix}- {ω}_{y , k}^{2} - {ω}_{z , k}^{2} & {ω}_{x , k} {ω}_{y , k} - {\dot{ω}}_{z , k} & {ω}_{x , k} {ω}_{z , k} + {\dot{ω}}_{y , k} \\ {ω}_{x , k} {ω}_{y , k} + {\dot{ω}}_{z , k} & - {ω}_{x , k}^{2} - {ω}_{z , k}^{2} & {ω}_{y , k} {ω}_{z , k} - {\dot{ω}}_{x , k} \\ {ω}_{x , k} {ω}_{z , k} - {\dot{ω}}_{y , k} & {ω}_{y , k} {ω}_{z , k} + {\dot{ω}}_{x , k} & - {ω}_{x , k}^{2} - {ω}_{y , k}^{2}\end{matrix} ] {r}_{j} = \\ {α}_{j , k} - [ \begin{matrix}- {ω}_{y , k}^{2} - {ω}_{z , k}^{2} & {ω}_{x , k} {ω}_{y , k} - \frac{{ω}_{z , k} - {ω}_{z , k - 1}}{Δ t} & {ω}_{x , k} {ω}_{z , k} + \frac{{ω}_{y , k} - {ω}_{y , k - 1}}{Δ t} \\ {ω}_{x , k} {ω}_{y , k} + \frac{{ω}_{z , k} - {ω}_{z , k - 1}}{Δ t} & - {ω}_{x , k}^{2} - {ω}_{z , k}^{2} & {ω}_{y , k} {ω}_{z , k} - \frac{{ω}_{x , k} - {ω}_{x , k - 1}}{Δ t} \\ {ω}_{x , k} {ω}_{z , k} - \frac{{ω}_{y , k} - {ω}_{y , k - 1}}{Δ t} & {ω}_{y , k} {ω}_{z , k} + \frac{{ω}_{x , k} - {ω}_{x , k - 1}}{Δ t} & - {ω}_{x , k}^{2} - {ω}_{y , k}^{2}\end{matrix} ] {r}_{j}\end{matrix} \qquad ( 6 )$$

From Equation (6), the k-th average acceleration α′ₖ, which is an average value of the k-th accelerations α_{1,k} to α_{n,k} detected by the sensor devices 2-1 to 2-n, is calculated based on Equation (7).

$${α}_{k}^{′} = \frac{{\sum }_{j = 1}^{n} {α}_{j , k}^{′}}{n} \qquad ( 7 )$$

The acceleration conversion unit 101 may convert the acceleration αⱼ applied to the j-th position r into a reference position acceleration αⱼ′ based on Equation (6) for each integer j of 1 or more and n or less. For example, first to n-th positions r₁ to rₙ are stored in the storage circuit 110.

The averaging unit 102 calculates an average acceleration α′ which is an average value of the reference position accelerations α₁′ to αₙ′ based on Equation (7).

The mismatch determination unit 103 determines whether the reference position accelerations α₁′ to αₙ′ match. Here, “the reference position accelerations α₁′ to αₙ′ match” is not limited to a case where all of the reference position accelerations α₁′ to αₙ′ match exactly, and also includes a case where a difference between the reference position accelerations α₁′ to αₙ′ is less than a predetermined threshold.

For example, the mismatch determination unit 103 calculates an absolute value of difference |αᵢ′−αⱼ′| of αᵢ′ and αⱼ′ for integers i and j (i≠j) of 1 or more and n or less, and determines that the reference position accelerations αᵢ′ to αₙ′ match when the absolute value of difference |αᵢ′−αⱼ′| is equal to or less than the predetermined threshold for all sets of the integers i and j (i≠j). In addition, when the absolute value of difference |αᵢ′−αⱼ′| is larger than the predetermined threshold for at least one set of the integers i and j (i≠j), the mismatch determination unit 103 determines that at least one of the reference position accelerations α₁′ to αₙ′ does not match the others.

Alternatively, the mismatch determination unit 103 calculates an absolute value of ratio |αᵢ′/αⱼ′| of αᵢ′ and αⱼ′ for the integers i and j (i≠j) of 1 or more and n or less, and determines that the reference position accelerations α₁′ to αₙ′ match when the absolute value of ratio |αᵢ′/αⱼ′| is included in a predetermined range for all the sets of the integers i and j (i≠j). In addition, when the absolute value of ratio |αᵢ′/αⱼ′| is not included in the predetermined range for at least one set of the integers i and j (i≠j), the mismatch determination unit 103 determines that at least one of the reference position accelerations α₁′ to αₙ′ does not match the others.

Then, the mismatch determination unit 103 generates a flag flg indicating a determination result. For example, the flag flg may be 0 when determined as match, and may be 1 when determined as mismatch.

The average acceleration α′ calculated by the averaging unit 102 and the flag flg generated by the mismatch determination unit 103 are transmitted to αₙ external device (not illustrated) via the communication circuit 120. For example, the external device may perform predetermined calculation using the average acceleration α′ when the flag flg indicates determination as match, and may not perform the predetermined calculation when the flag flg indicates determination as mismatch.

The sensor device 2 is not limited to the configuration illustrated in FIG. 5, and may be an inertia measurement unit including a configuration shown in FIG. 9. In FIG. 9, the same components as those in FIG. 5 are denoted by the same reference numerals, and description thereof is omitted or simplified. An example of FIG. 9 is different from the configuration of FIG. 5 in that the sensor device 2 includes two acceleration sensors 27-1 and 27-2.

The three-axis acceleration sensor 27-1 detects an acceleration Aₐ₁ in the direction along the a-axis, an acceleration A_{b1} in the direction along the b-axis, and an acceleration A_{c1} in the direction along the c-axis. The three-axis acceleration sensor 27-2 detects an acceleration Aₐ₂ in the direction along the a-axis, an acceleration A_{b2} in the direction along the b-axis, and an acceleration A_{c2} in the direction along the c-axis. The three detection axes including the a-axis, the b-axis, and the c-axis are defined for each sensor device 2.

The correction circuit 28 generates the corrected signals by executing the misalignment correction in which the predetermined correction coefficient such as the rotation matrix is applied to signals output from the three-axis acceleration sensor 27-1, the three-axis acceleration sensor 27-2, the first angular velocity sensor 26a, the second angular velocity sensor 26b, and the third angular velocity sensor 26c. The three detection axes forming a three-dimensional orthogonal coordinate system are set for each sensor device 2. Then, the correction circuit 28 averages the corrected signals of the three-axis accelerations Aₐ₁, A_{b1}, and A_{c1} and the corrected signals of the three-axis accelerations Aₐ₂, A_{b2}, and A_{c2} to calculate the corrected signals having reduced noise. In addition, the correction circuit 28 corrects offset errors and scale factor errors included in the signals output from the three-axis acceleration sensor 27-1, the three-axis acceleration sensor 27-2, the first angular velocity sensor 26a, the second angular velocity sensor 26b, and the third angular velocity sensor 26c. The correction circuit 28 outputs the corrected signals to the processing circuit 100 via the interface circuit 29.

Since other configurations of the sensor device 2 illustrated in FIG. 9 are the same as those of FIG. 5, description thereof will be omitted.

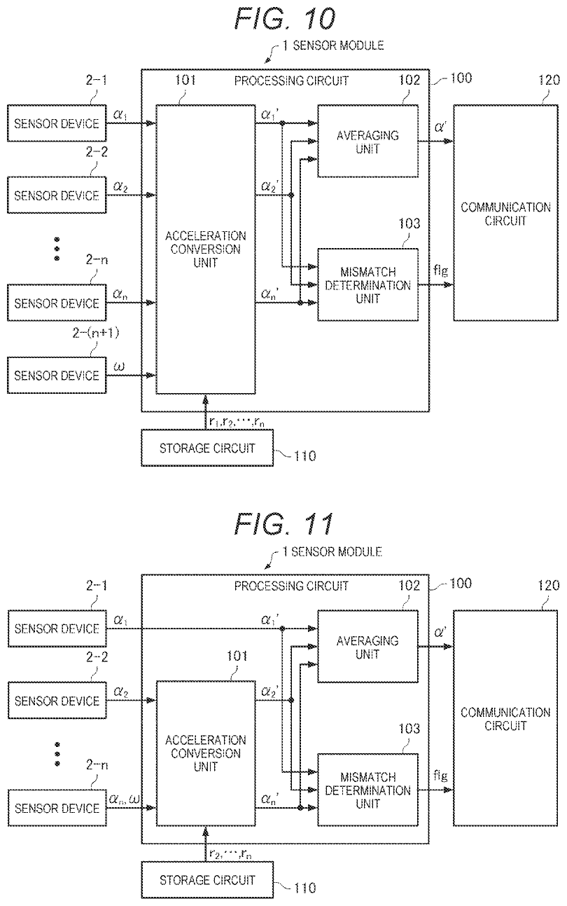

Further, the sensor module 1 according to the first embodiment is not limited to the configuration illustrated in FIG. 1, and may have, for example, a configuration illustrated in FIG. 10. In FIG. 10, the same components as those in FIG. 1 are denoted by the same reference numerals, and description thereof is omitted or simplified. An example of FIG. 10 is different from the configuration of FIG. 1 in that the sensor module 1 includes a sensor device 2-(n+1).

The sensor devices 2-1 to 2-n are accommodated in a housing (not illustrated) of the sensor module 1, and detect accelerations α₁ to αₙ applied to first to n-th positions of the housing, respectively. That is, for each integer j of 1 or more and n or less, the sensor device 2-j includes at least an acceleration sensor provided at the j-th position, and the acceleration sensor detects the acceleration αⱼ. The sensor device 2-(n+1) detects the angular velocity ω applied to the housing of the sensor module 1. That is, the sensor device 2-(n+1) includes αₙ angular velocity sensor, and the angular velocity sensor detects the angular velocity ω applied to the housing.

For example, the sensor devices 2-1 to 2-n may be three-axis acceleration sensor devices, and the sensor device 2-(n+1) may be a three-axis angular velocity sensor. Further, each of the first to (n+1)-th sensor devices 2-1 to 2-(n+1) may be an inertia measurement unit.

The acceleration conversion unit 101 converts, based on the angular velocity ω applied to the housing of the sensor module 1 and detected by the sensor device 2-(n+1), the accelerations α₁ to αₙ respectively applied to the first to n-th positions detected by the sensor devices 2-1 to 2-n into the reference position accelerations α₁′ to αₙ′, respectively, the reference position accelerations being accelerations applied to the predetermined reference position of the housing.

Since other configurations of the sensor module 1 illustrated in FIG. 10 are the same as those of FIG. 1, description thereof will be omitted.

In the sensor module 1 according to the first embodiment, the sensor devices 2-1 to 2-n are an example of “first to n-th sensor devices”. The sensor devices 2-1 to 2-(n+1) are an example of αₙ “first to (n+1)-th sensor device”. The accelerations α₁ to αₙ are an example of “first to n-th accelerations”. Further, the reference position accelerations α₁′ to αₙ′ are an example of “first to n-th reference position accelerations”.

In the sensor module 1 according to the first embodiment described above, the processing circuit 100 converts, based on the angular velocity ω applied to the housing, the accelerations α₁ to αₙ applied to the first to n-th positions r₁ to rₙ of the housing and detected by the sensor devices 2-1 to 2-n into the reference position accelerations α₁′ to αₙ′ applied to the reference position of the housing. Therefore, according to the sensor module 1 of the first embodiment, the accelerations α₁ to αₙ can be corrected even when a rotational motion is applied to the sensor devices 2-1 to 2-n.

According to the sensor module 1 of the first embodiment, it is possible to calculate the average acceleration α′ in which random noise components are reduced by averaging processing of the averaging unit 102 of the processing circuit 100.

Further, according to the sensor module 1 of the first embodiment, for example, the external device can determine whether all of the three-axis acceleration sensors 27 included in the sensor devices 2-1 to 2-n are normal or at least one of the three-axis acceleration sensors 27 is out of order based on the flag flg indicating the determination result obtained by the mismatch determination unit 103 of the processing circuit 100.

### 2. Second Embodiment

Hereinafter, regarding a sensor module according to the second embodiment, the same components as those in the first embodiment are denoted by the same reference numerals, description overlapping with that of the first embodiment is omitted or simplified, and contents different from those of the first embodiment will be mainly described.

FIG. 11 is a diagram illustrating a configuration of the sensor module 1 according to the second embodiment. As illustrated in FIG. 11, as in the first embodiment, the sensor module 1 according to the second embodiment includes the sensor devices 2-1 to 2-n, the processing circuit 100, the storage circuit 110, and the communication circuit 120. n is an integer of 2 or more.

In the sensor module 1 according to the second embodiment, the processing circuit 100 sets the first position r₁ as a predetermined reference position of a housing, sets the acceleration α₁ detected by the sensor device 2-1 as the reference position acceleration α₁′ which is the acceleration applied to the reference position, and converts, based on the angular velocity ω applied to the housing, the accelerations α₂ to αₙ and detected by the sensor devices 2-2 to 2-n into the reference position accelerations α₂′ to αₙ′, respectively, the reference position accelerations being the accelerations applied to the reference position.

As illustrated in FIG. 11, the processing circuit 100 includes the acceleration conversion unit 101, the averaging unit 102, and the mismatch determination unit 103 as in the first embodiment.

The acceleration conversion unit 101 sets the first position r₁ at which the acceleration sensor included in the sensor device 2-1 is mounted as the predetermined reference position of the housing, and converts, based on the angular velocity ω applied to the housing of the sensor module 1 and detected by the sensor device 2-n, the accelerations α₂ to αₙ applied to the second to n-th positions r₂ to rₙ and detected by the sensor devices 2-2 to 2-n into the reference position accelerations α₂′ to αₙ′ applied to the first position r₁, respectively, the first position being the reference position of the housing.

The acceleration conversion unit 101 may convert the acceleration αⱼ applied to the j-th position r into the reference position acceleration αⱼ′ based on Equation (6) described above for each integer j of 2 or more and n or less. The second to n-th positions r₂ to rₙ are positions with respect to the first position r₁, and are, for example, stored in the storage circuit 110.

The averaging unit 102 calculates the average acceleration α′, which is the average value of the reference position accelerations α₁′ to αₙ′, based on Equation (7) described above. However, the reference position acceleration α₁′ is the acceleration α₁ detected by the sensor device 2-1.

Since a function of the mismatch determination unit 103 is the same as that of the first embodiment, description thereof will be omitted. Other configurations, functions, and structures of the sensor module 1 according to the second embodiment are the same as those of the first embodiment, and description thereof will be omitted.

The sensor module 1 according to the second embodiment is not limited to the configuration illustrated in FIG. 11, and may further include, for example, the sensor device 2-(n+1) that detects the angular velocity ω applied to the housing of the sensor module 1 with respect to the configuration illustrated in FIG. 11 as in the configuration illustrated in FIG. 10. In this case, the acceleration conversion unit 101 converts, based on the angular velocity ω applied to the housing of the sensor module 1 and detected by the sensor device 2-(n+1), the accelerations α₂ to αₙ respectively applied to the second to n-th positions r₂ to rₙ and detected by the sensor devices 2-2 to 2-n into the reference position accelerations α₂′ to αₙ′, respectively, the reference position accelerations being accelerations applied to the first position r₁.

In the sensor module 1 according to the second embodiment, the sensor devices 2-1 to 2-n are an example of “first to n-th sensor devices”. The sensor devices 2-1 to 2-(n+1) are an example of αₙ “first to (n+1)-th sensor device”. The accelerations α₁ to αₙ are an example of “first to n-th accelerations”. Further, the reference position accelerations α₁′ to αₙ′ are an example of “first to n-th reference position accelerations”.

In the sensor module 1 according to the second embodiment described above, the processing circuit 100 sets the acceleration α₁ applied to the first position r₁ of the housing and detected by the sensor device 2-1 to the reference position acceleration α₁′ applied to the first position r₁ which is the reference position, and converts, based on the angular velocity ω applied to the housing, the accelerations α₂ to αₙ applied to the second to n-th positions r₂ to rₙ of the housing and detected by the sensor devices 2-2 to 2-n into the reference position accelerations α₂′ to αₙ′ applied to the first position r₁. Therefore, according to the sensor module 1 of the second embodiment, the accelerations α₁ to αₙ can be corrected even when a rotational motion is applied to the sensor devices 2-1 to 2-n.

According to the sensor module 1 of the second embodiment, since the acceleration α₁ applied to the first position r₁ of the housing can be set as the reference position acceleration α₁′ applied to the first position r₁ which is the reference position, a calculation load for calculating the reference position accelerations α₁′ to αₙ′ is smaller than that of the sensor module 1 according to the first embodiment.

According to the sensor module 1 of the second embodiment, it is possible to calculate the average acceleration α′ in which random noise components are reduced by averaging processing of the averaging unit 102 of the processing circuit 100.

Further, according to the sensor module 1 of the second embodiment, for example, αₙ external device can determine, based on the flag flg indicating a determination result obtained by the mismatch determination unit 103 of the processing circuit 100, whether all of the three-axis acceleration sensors 27 included in the sensor devices 2-1 to 2-n are normal or at least one of the three-axis acceleration sensors 27 is out of order.

### 3. Third Embodiment

Hereinafter, regarding a sensor module according to a third embodiment, the same components as those in the first embodiment or the second embodiment are denoted by the same reference numerals, description overlapping with that of the first embodiment or the second embodiment is omitted or simplified, and contents different from those of the first embodiment and the second embodiment will be mainly described.

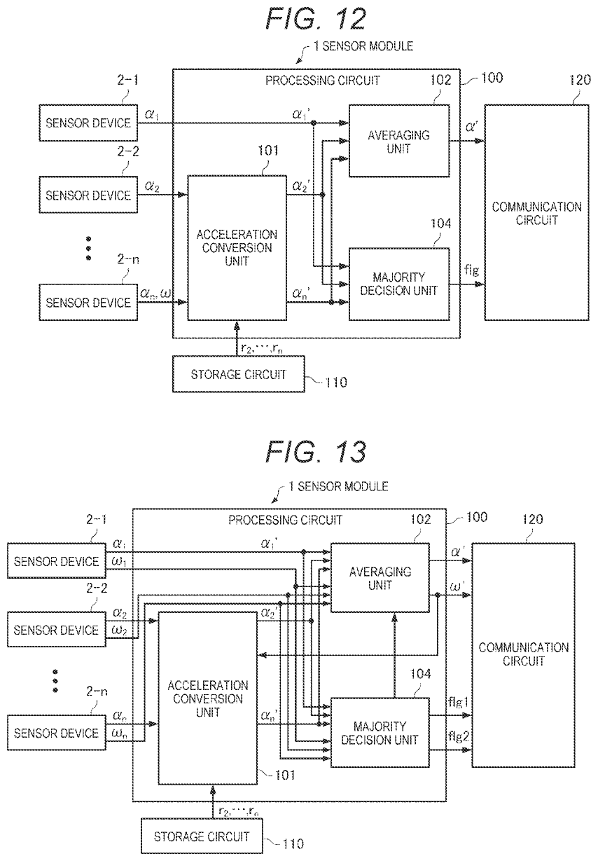

FIG. 12 is a diagram illustrating a configuration of the sensor module 1 according to the third embodiment. As illustrated in FIG. 12, as in the first embodiment or the second embodiment, the sensor module 1 according to the third embodiment includes the sensor devices 2-1 to 2-n, the processing circuit 100, the storage circuit 110, and the communication circuit 120. Here, n is an integer of 3 or more.

As illustrated in FIG. 12, the processing circuit 100 includes the acceleration conversion unit 101, the averaging unit 102, and a majority decision unit 104.

Since functions of the acceleration conversion unit 101 are the same as those of the second embodiment, description thereof will be omitted.

The majority decision unit 104 determines whether each of the reference position accelerations α₁′ to αₙ′ is normal by majority decision on the reference position accelerations α₁′ to αₙ′.

For example, the majority decision unit 104 calculates an absolute value of difference |α₁′−αⱼ′| of αᵢ′ and αⱼ′ for integers i and j (i≠j) of 1 or more and n or less, and determines that the reference position accelerations αₖ′ and αₗ′ are normal when the absolute value of difference |αₖ′−αₗ′ is equal to or less than a predetermined threshold for any set of the integers k and l (k≠l). Further, for any set of integers k, l, and m (k≠l≠m), when an absolute value of difference |αₖ′−αₗ′I is larger than the predetermined threshold, an absolute value of difference |αₖ′−αₘ′| is larger than the predetermined threshold, and an absolute value of difference |αₗ′−αₘ′| is equal to or less than the predetermined threshold, the majority decision unit 104 determines that the reference position acceleration αₖ′ is abnormal and the reference position accelerations αₗ′ and αₘ′ are normal.

Alternatively, the majority decision unit 104 calculates an absolute value of ratio |αᵢ′/αⱼ′| of αᵢ′ and αⱼ′ for the integers i and j (i≠j) of 1 or more and n or less, and determines that the reference position accelerations αₖ′ and αₗ′ are normal when the absolute value of ratio |αₖ′/αₗ′| is included in the predetermined range for any set of the integers k and l (k≠l). In addition, for any set of the integers k, l, and m (k≠l≠m), when an absolute value of ratio |αₖ′/αₗ′| is not included in the predetermined range, an absolute value of ratio |αₖ′/αₘ′| is not included in the predetermined range, and an absolute value of ratio |αₗ′/αₘ′| is included in the predetermined range, the majority decision unit 104 determines that the reference position acceleration αₖ′ is abnormal and the reference position accelerations αₗ′ and αₘ′ are normal.

Then, the majority decision unit 104 generates the flag flg indicating a determination result. For example, the flag flg may be n-bit data, each being 1 when the reference position acceleration α₁′ to αₙ′ is normal and 0 when abnormal.

The averaging unit 102 calculates, based on a majority decision result obtained by the majority decision unit 104, the average acceleration α′, which is αₙ average value of normal accelerations among the reference position accelerations α₁′ to αₙ′. For example, when the reference position acceleration α₁′ is abnormal and the reference position accelerations α₂′ to αₙ′ are normal, the averaging unit 102 calculates the average acceleration α′ of the reference position accelerations α₂′ to αₙ′.

The average acceleration α′ calculated by the averaging unit 102 and the flag flg generated by the majority decision unit 104 are transmitted to αₙ external device (not illustrated) via the communication circuit 120. For example, the external device may perform predetermined calculation using the average acceleration α′.

Other configurations, functions, and structures of the sensor module 1 according to the third embodiment are the same as those of the first embodiment or the second embodiment, and description thereof will be omitted.

The sensor module 1 according to the third embodiment is not limited to the configuration illustrated in FIG. 12, and may further include, for example, the sensor device 2-(n+1) that detects the angular velocity ω applied to a housing of the sensor module 1 with respect to the configuration illustrated in FIG. 12 as in the configuration illustrated in FIG. 10. In this case, the acceleration conversion unit 101 converts, based on the angular velocity ω applied to the housing of the sensor module 1 and detected by the sensor device 2-(n+1), the accelerations α₂ to αₙ respectively applied to the second to n-th positions r₂ to rₙ and detected by the sensor devices 2-2 to 2-n into the reference position accelerations α₂′ to αₙ′, respectively, the reference position accelerations being accelerations applied to the first position r₁. In the sensor module 1 according to the third embodiment, as in the configuration illustrated in FIG. 1, the acceleration conversion unit 101 may convert, based on the angular velocity ω applied to the housing of the sensor module 1 and detected by the sensor device 2-n, the accelerations α₁ to αₙ respectively applied to the first to n-th positions and detected by the sensor devices 2-1 to 2-n into the reference position accelerations α₁′ to αₙ′, respectively, the reference position accelerations being the accelerations applied to the predetermined reference position of the housing.

In the sensor module 1 according to the third embodiment, the sensor devices 2-1 to 2-n are an example of “first to n-th sensor devices”. The sensor devices 2-1 to 2-(n+1) are an example of αₙ “first to (n+1)-th sensor device”. The accelerations α₁ to αₙ are an example of “first to n-th accelerations”. Further, the reference position accelerations α₁′ to αₙ′ are an example of “first to n-th reference position accelerations”.

In the sensor module 1 according to the third embodiment described above, the processing circuit 100 sets the acceleration α₁ applied to the first position rᵢ of the housing and detected by the sensor device 2-1 to the reference position acceleration α₁′ applied to the first position r₁ which is the reference position, and converts, based on the angular velocity ω applied to the housing, the accelerations α₂ to αₙ applied to the second to n-th positions r₂ to rₙ of the housing and detected by the sensor devices 2-2 to 2-n into the reference position accelerations α₂′ to αₙ′ applied to the first position r₁. Alternatively, the processing circuit 100 converts, based on the angular velocity ω applied to the housing, the accelerations α₁ to αₙ applied to the first to n-th positions r₁ to rₙ of the housing and detected by the sensor devices 2-1 to 2-n into the reference position accelerations α₁′ to αₙ′ applied to the reference position of the housing. Therefore, according to the sensor module 1 of the third embodiment, the accelerations α₁ to αₙ can be corrected even when a rotational motion is applied to the sensor devices 2-1 to 2-n.

According to the sensor module 1 of the third embodiment, when the acceleration α₁ applied to the first position rᵢ of the housing is set to the reference position acceleration α₁′ applied to the first position rᵢ which is the reference position, a calculation load for calculating the reference position accelerations α₁′ to αₙ′ is smaller than that of the sensor module 1 according to the first embodiment.

According to the sensor module 1 of the third embodiment, it is possible to calculate the average acceleration α′ in which random noise components are reduced by averaging processing of the averaging unit 102 of the processing circuit 100. Even when any one of the sensor devices 2-1 to 2-n is out of order, the processing circuit 100 can calculate the average acceleration α′ by using the acceleration detected by the normal sensor device.

Further, according to the sensor module 1 of the third embodiment, for example, the external device can determine, based on the flag flg indicating a determination result obtained by the majority decision unit 104 of the processing circuit 100, whether the three-axis acceleration sensor 27 included in each of the sensor devices 2-1 to 2-n is normal or out of order.

### 4. Fourth Embodiment

Hereinafter, regarding a sensor module according to a fourth embodiment, the same components as those in the first to third embodiments are denoted by the same reference numerals, description overlapping with that of the first to third embodiments is omitted or simplified, and contents different from those of the first to third embodiments will be mainly described.

FIG. 13 is a diagram illustrating a configuration of the sensor module 1 according to the fourth embodiment. As illustrated in FIG. 13, as in the first embodiment, the second embodiment, or the third embodiment, the sensor module 1 according to the fourth embodiment includes the sensor devices 2-1 to 2-n, the processing circuit 100, the storage circuit 110, and the communication circuit 120. Here, as in the third embodiment, n is an integer of 3 or more.

In the sensor module 1 according to the fourth embodiment, each of the sensor devices 2-1 to 2-n is an inertia measurement unit. For each integer j of 1 or more and n or less, the sensor device 2-j detects the acceleration αⱼ applied to the j-th position of a housing of the sensor module 1 and detects the angular velocity ω applied to the housing. A configuration of the sensor devices 2-1 to 2-n is the same as that of FIG. 5 or FIG. 9, and illustration and description thereof will be omitted.

As illustrated in FIG. 13, the processing circuit 100 includes the acceleration conversion unit 101, the averaging unit 102, and the majority decision unit 104 as in the third embodiment.

The acceleration conversion unit 101 converts, based on αₙ average angular velocity ω′ that is an average value of the angular velocities ω₁ to ωₙ calculated by the averaging unit 102 as the angular velocity applied to the housing of the sensor module 1, the accelerations α₁ to αₙ respectively applied to the second to n-th positions r₂ to rₙ and detected by the sensor devices 2-2 to 2-n into the reference position accelerations α₁′ to αₙ′, respectively, the reference position accelerations being the accelerations applied to the first position rᵢ of the housing. The acceleration conversion unit 101 may convert the acceleration αⱼ applied to the j-th position re into the reference position acceleration αⱼ′ based on Equation (6) described above for each integer j of 2 or more and n or less.

The majority decision unit 104 determines whether each of the reference position accelerations α₁′ to αₙ′ is normal by majority decision on the reference position accelerations α₁′ to αₙ′ as in the third embodiment. In addition, the majority decision unit 104 determines whether each of the angular velocities ω₁ to ωₙ is normal based on majority decision on the angular velocities ω₁ to ωₙ.

For example, the majority decision unit 104 calculates an absolute value of difference |ωᵢ−ωⱼ| of ω₁ and w for the integers i and j (i≠j) of 1 or more and n or less, and determines that the angular velocities ωₖ and ω₁ are normal when an absolute value |ωₖ−ωₗ| is equal to or less than a predetermined threshold for any set of the integers k and l (k≠l). In addition, for any set of integers k, l, and m (k≠l≠m), when the absolute value |ωₖ−ωₗ| is larger than the predetermined threshold, an absolute value |ωₖ−ωₘ| is larger than a predetermined threshold, and an absolute value |ωₗ−ωₘ| is equal to or less than a predetermined threshold, the majority decision unit 104 determines that the angular velocity ωₖ is abnormal and the angular velocities ωₗ and ωₘ are normal.

Alternatively, the majority decision unit 104 calculates an absolute value of ratio |ωᵢ/αⱼ| of ωᵢ and ωⱼ for the integers i and j (i≠j) of 1 or more and n or less, and determines that the angular velocities ωₖ and ωₗ are normal when an absolute value of ratio ωₖ/ωₗ| is included in a predetermined range for any set of the integers k and l (k≠l). For any set of integers k, l, and m (k≠l≠m), when the absolute value of ratio ωₖ/ωₗ| is not included in the predetermined range, an absolute value of ratio |ωₖ/ωₘ| is not included in a predetermined range, and an absolute value of ratio |ωₗ/ωₘ| is included in a predetermined range, the majority decision unit 104 determines that the angular velocity ωₖ is abnormal and the angular velocities ωₗ and ωₘ are normal.

Then, the majority decision unit 104 generates a first flag flg1 and a second flag flg2 indicating determination results. For example, the first flag flg1 may be n-bit data that is 1 when the reference position accelerations α₁′ to αₙ′ are normal and is 0 when abnormal. Further, the second flag flg2 may be n-bit data that is 1 when the angular velocities ω₁ to ωₙ are normal and is 0 when abnormal.

The averaging unit 102 calculates, based on a majority decision result obtained by the majority decision unit 104, the average acceleration α′, which is αₙ average value of normal accelerations among the reference position accelerations α₁′ to αₙ′. For example, when the reference position acceleration α₁′ is abnormal and the reference position accelerations α₂′ to αₙ′ are normal, the averaging unit 102 calculates the average acceleration α′ of the reference position accelerations α₂′ to αₙ′. In addition, the averaging unit 102 calculates, based on the majority decision result obtained by the majority decision unit 104, the average angular velocity ω′, which is an average value of normal angular velocities among the angular velocities ωₗ to ωₙ. For example, when the angular velocity ω₁ is abnormal and the angular velocities ω₂ to ωₙ are normal, the averaging unit 102 calculates the average angular velocity ω′ of the angular velocities ω₂ to ωₙ.

The average acceleration α′ and the average angular velocity ω′ which are calculated by the averaging unit 102, and the first flag flg1 and the second flag flg2 which are generated by the majority decision unit 104 are transmitted to an external device (not illustrated) via the communication circuit 120. For example, the external device may perform predetermined calculation using the average acceleration α′ and the average angular velocity ω′.

Other configurations, functions, and structures of the sensor module 1 according to the fourth embodiment are the same as those of the first embodiment, the second embodiment, or the third embodiment, and description thereof will be omitted.

The sensor module 1 according to the fourth embodiment is not limited to the configuration illustrated in FIG. 13, and for example, the acceleration conversion unit 101 may convert, based on any one of the angular velocities ω₁ to ωₙ detected by the sensor devices 2-1 to 2-n, the accelerations α₁ to αₙ respectively applied to the first to n-th positions and detected by the sensor devices 2-1 to 2-n into the reference position accelerations α₁′ to αₙ′, respectively, the reference position accelerations being the accelerations applied to the predetermined reference position of the housing.

In the sensor module 1 according to the fourth embodiment, the sensor devices 2-1 to 2-n are an example of “first to n-th sensor devices”. The accelerations α₁ to αₙ are an example of “first to n-th accelerations”. Further, the reference position accelerations α₁′ to αₙ′ are αₙ example of “first to n-th reference position accelerations”. Further, the angular velocities ω₁ to ωₙ are an example of “first to n-th angular velocities”.

In the sensor module 1 according to the fourth embodiment described above, the processing circuit 100 sets the acceleration α₁ applied to the first position rᵢ of the housing and detected by the sensor device 2-1 to the reference position acceleration α₁′ applied to the first position r₁ which is the reference position, and converts, based on the angular velocity ω applied to the housing, the accelerations α₂ to αₙ applied to the second to n-th positions r₂ to rₙ of the housing and detected by the sensor devices 2-2 to 2-n into the reference position accelerations α₂′ to αₙ′ applied to the first position r₁. Alternatively, the processing circuit 100 converts, based on the angular velocity ω applied to the housing, the accelerations α₁ to αₙ applied to the first to n-th positions r₁ to rₙ of the housing and detected by the sensor devices 2-1 to 2-n into the reference position accelerations α₁′ to αₙ′ applied to the reference position of the housing. Therefore, according to the sensor module 1 of the fourth embodiment, the accelerations α₁ to αₙ can be corrected even when a rotational motion is applied to the sensor devices 2-1 to 2-n.

According to the sensor module 1 of the fourth embodiment, when the acceleration α₁ applied to the first position r₁ of the housing is set to the reference position acceleration α₁′ applied to the first position r₁ which is the reference position, a calculation load for calculating the reference position accelerations α₂′ to αₙ′ is smaller than that of the sensor module 1 according to the first embodiment.

According to the sensor module 1 of the fourth embodiment, it is possible to calculate the average acceleration α′ and the average angular velocity ω′ in which random noise components are reduced by averaging processing of the averaging unit 102 of the processing circuit 100. Even when any one of the sensor devices 2-1 to 2-n is out of order, the processing circuit 100 can calculate the average acceleration α′ and the average angular velocity ω′ by using the acceleration and the angular velocity which are detected by the normal sensor device.

Further, according to the sensor module 1 of the fourth embodiment, for example, the external device can determine, based on the first flag flg1 indicating the determination result obtained by the majority decision unit 104 of the processing circuit 100, whether the three-axis acceleration sensor 27 included in each of the sensor devices 2-1 to 2-n is normal or out of order. For example, the external device can determine, based on the second flag flg2 indicating the determination result obtained by the majority decision unit 104 of the processing circuit 100, whether the first angular velocity sensor 26a, the second angular velocity sensor 26b, and the third angular velocity sensor 26c included in each of the sensor devices 2-1 to 2-n are normal or out of order.

The present disclosure is not limited to the embodiment, and various modifications can be made within the scope of the gist of the present disclosure.

The above-described embodiments and modifications are examples, and the present disclosure is not limited thereto. For example, the embodiments and the modifications may be combined as appropriate.

The present disclosure includes substantially the same configurations as the configurations described in the embodiments, such as a configuration having the same function, method, and result or a configuration having the same object and effect. The present disclosure includes a configuration in which a non-essential portion of the configuration described in the embodiments is replaced. The present disclosure may include a configuration capable of achieving the same function and effect or a configuration capable of achieving the same object as the configuration described in the embodiments. The present disclosure includes a configuration obtained by adding a known technique to the configuration described in the embodiments.

The following contents are derived from the above-described embodiments and modifications.

An aspect of a sensor module includes:
a housing;
first to n-th sensor devices accommodated in the housing and configured to detect first to n-th accelerations respectively applied to first to n-th positions of the housing, n being an integer of 2 or more; and
a processing circuit configured to convert, based on αₙ angular velocity applied to the housing, the first to n-th accelerations into first to n-th reference position accelerations, respectively, the reference position accelerations being accelerations applied to a predetermined reference position of the housing.

According to the sensor module, since the first to n-th accelerations applied to the first to n-th positions of the housing and detected by the first to n-th sensor devices is converted, based on the angular velocity applied to the housing, into the first to n-th reference position accelerations applied to the reference position, the first to n-th accelerations can be corrected even when a rotational motion is applied to the first to n-th sensor devices.

Another aspect of a sensor module includes: a housing;
first to n-th sensor devices accommodated in the housing and configured to detect first to n-th accelerations respectively applied to first to n-th positions of the housing, n being an integer of 2 or more; and
a processing circuit configured to set the first position as a predetermined reference position of the housing to set the first acceleration as a first reference position acceleration that is an acceleration applied to the reference position, and convert, based on an angular velocity applied to the housing, the second to n-th accelerations into second to n-th reference position accelerations, respectively, the reference position accelerations being accelerations applied to the reference position.

According to the sensor module, since the first acceleration applied to the first position of the housing and detected by the first sensor device is set as the first reference position acceleration applied to the first position which is the reference position, and the second to n-th accelerations applied to the second to n-th positions of the housing and detected by the second to n-th sensor devices is converted, based on the angular velocity of the housing, into the second to n-th reference position accelerations applied to the first position, the first to n-th accelerations can be corrected even when a rotational motion is applied to the first to n-th sensor devices.

Further, according to the sensor module, since the first acceleration applied to the first position of the housing can be set as the first reference position acceleration applied to the first position which is the reference position, a calculation load for calculating the first to n-th reference position accelerations is reduced.

In an aspect of the sensor module, the processing circuit may determine whether the first to n-th reference position accelerations match.

According to the sensor module, for example, the external device can determine, based on a determination result, whether all of the acceleration sensors included in the first to n-th sensor devices are normal or at least one of the acceleration sensors is out of order.

In an aspect of the sensor module,
the integer n may be 3 or more, and
the processing circuit may determine whether each of the first to n-th reference position accelerations is normal by majority decision on the first to n-th reference position accelerations.

According to the sensor module, for example, the external device can determine, based on the determination result, whether the acceleration sensor included in each of the first to n-th sensor devices is normal or out of order.

In an aspect of the sensor module,
the processing circuit may calculate an average value of normal accelerations among the first to n-th reference position accelerations.

According to the sensor module, it is possible to calculate an acceleration in which random noise components are reduced by averaging. Further, even when any one of the first to n-th sensor devices is out of order, the processing circuit can calculate the average acceleration by using the acceleration detected by the normal sensor devices.

An aspect of the sensor module may further include
a (n+1)-th sensor device configured to detect the angular velocity.

In αₙ aspect of the sensor module,
the n-th sensor device may detect the angular velocity.

In αₙ aspect of the sensor module,
for each integer j of 1 or more and n or less, the j-th sensor device may detect a j-th angular velocity, and
the processing circuit may determine whether each of the first to n-th angular velocities is normal by majority decision on the first to n-th angular velocities, and calculate αₙ average value of normal angular velocities among the first to n-th angular velocities as the angular velocity.

According to the sensor module, it is possible to calculate αₙ angular velocity in which random noise components are reduced by averaging, and for example, the external device can determine, based on a determination result, whether the angular velocity sensor included in each of the first to n-th sensor devices is normal or out of order.

What is claimed is:

1. A sensor module comprising:
a housing;
first to n-th sensor devices accommodated in the housing and configured to detect first to n-th accelerations respectively applied to first to n-th positions of the housing, n being an integer of 2 or more; and
a processing circuit configured to convert, based on αₙ angular velocity applied to the housing, the first to n-th accelerations into first to n-th reference position accelerations, respectively, the reference position accelerations being accelerations applied to a predetermined reference position of the housing.

2. A sensor module comprising:
a housing;
first to n-th sensor devices accommodated in the housing and configured to detect first to n-th accelerations respectively applied to first to n-th positions of the housing, n being an integer of 2 or more; and
a processing circuit configured to set the first position as a predetermined reference position of the housing to set the first acceleration as a first reference position acceleration that is an acceleration applied to the reference position, and convert, based on αₙ angular velocity applied to the housing, the second to n-th accelerations into second to n-th reference position accelerations, respectively, the reference position accelerations being accelerations applied to the reference position.

3. The sensor module according to claim 1, wherein
the processing circuit determines whether the first to n-th reference position accelerations match.

4. The sensor module according to claim 1, wherein
the integer n is 3 or more, and
the processing circuit determines whether each of the first to n-th reference position accelerations is normal by majority decision on the first to n-th reference position accelerations.

5. The sensor module according to claim 4, wherein
the processing circuit calculates αₙ average value of normal accelerations among the first to n-th reference position accelerations.

6. The sensor module according to claim 1, further comprising:
αₙ (n+1)-th sensor device configured to detect the angular velocity.

7. The sensor module according to claim 1, wherein
the n-th sensor device detects the angular velocity.

8. The sensor module according to claim 1, wherein
for each integer j of 1 or more and n or less, the j-th sensor device detects a j-th angular velocity, and
the processing circuit determines whether each of first to n-th angular velocities is normal by majority decision on the first to n-th angular velocities, and calculates αₙ average value of normal angular velocities among the first to n-th angular velocities as the angular velocity.
